(19) United States
(12) Patent Application Publication
(10) Pub. No.: US 2021/0370167 A1
(43) Pub. Date: Dec. 2, 2021

(54) System and method for peer-to-peep wireless gaming

(71) Applicant: TODD CHRISTOPHER ROBINSON, MCLEAN, VA (US)

(72) Inventor: TODD CHRISTOPHER ROBINSON, MCLEAN, VA (US)

(21) Appl. No.: 17/324,214

(22) Filed: May 19, 2021

Related U.S. Application Data
(60) Provisional application No. 63/027,696, filed on May 20, 2020.

(51) Int. Cl. A63F 13/34

(52) U.S. Cl. CPC A63F 13/34

(57) ABSTRACT

A system and method for a device with one of more processors to begin start a streaming of audio and video; receive combinations of the number of times ephemeral elements of streaming audio and video occur; register, store and transmit haptic user inputs of player; compute the player inputs to produce a performance score.

### BACKGROUND OF THE INVENTION

Puzzle video games are widely available on the internet to test the cognitive and memory recall ability players using a variety of audio and visual media. Puzzles games can be made based on various structures of numbers, objects, pictures, sounds and words. Players of games are tasked to use problem solving skills and memory recall to earn points for their performance. Puzzle games in video game format are enjoyed both alone or in groups in the spirit of competition various levels of difficulty can be played.

Typically puzzle video games are generated from 2D and/or 3D graphics. Popular puzzle video game formats include match-three and word search. Recorded and live streamed media content have not been used for video game development in the scope of adding gamification based on the tracking of repetitive ephemeral elements. This is a result of viewing recorded and live streamed media content through a narrow lens with respect to gamification. Developers have not been able to find consistent and thematic gamification schemes to apply to various forms of recorded and live media such as music video, sports, TV comedy & drama, news television and movies.

### SUMMARY OF THE INVENTION

The present invention provides methods and systems for adding gamification to recorded and live streamed media content for video gameplay.

In one aspect, the invention provides a system for creating visual puzzle video gameplay from recorded and live streamed video, comprising: displaying trivia questions to determine the number of occurrences of ephemeral elements within media content; providing ephemeral elements as symbols in a network interface for user haptic inputs on the user's device; determining user performance.

In another aspect, the invention provides a system for creating an audio puzzle video gameplay from recorded and live streamed audio, comprising: displaying questions to determine the number of occurrences of ephemeral elements within media content; providing ephemeral elements as symbols in network interface for user haptic inputs on the user's devices; determining user performance.

In another aspect, the invention provides a method for configuring one or more ephemeral elements symbols and words within the network interface as part of the gameplay environment.

In another aspect, the invention provides a system for users to play record and live streamed media content using a secondary device for viewing and a separate device for executing gameplay events.

### BRIEF DESCRIPTION OF THE SEVERAL VIEWS OF THE DRAWINGS

Certain features of the subject technology are set forth in the appended claims. However, the accompanying drawings, which are included to provide further understanding, illustrate disclosed aspects and together with the description serve to explain the principles of the subject technology. In drawings:

FIG. 1 illustrates an example of a network environment in which some aspects of the technology can be implemented.

FIG. 2 illustrates an example of a network environment containing a secondary view device in which some aspects of the technology can be implemented

FIG. 3 illustrates examples of ephemeral elements in media content in connection with gameplay events.

FIGS. 4A and 4B illustrate game scenes from a video game in accordance with aspects of the invention;

FIGS. 5A and 5B illustrate game scenes from a video game in accordance with aspects of the invention; and

FIG. 6 is a flowchart of process for a video game in accordance with aspects of the invention.

### DETAILED DESCRIPTION OF THE INVENTION

The detailed description set forth below is intended as a description of various configurations of the subject technology and is not intended to represent the only configurations in which the technology can be practiced. The appended drawings are incorporated herein and constitute a part of the detailed description. The detailed description includes specific details for the purpose of providing a more thorough understanding of the technology. However, it will be clear and apparent that the technology is not limited to the specific details set forth herein and may be practiced without these details. In some instances, structures and components are shown in block diagram form in order to avoid obscuring the concepts of the subject technology.

Competitive gaming has been developed to be enjoyed by players via consoles, mobile and PC systems who play video games. Video games for these systems cover a wide ranges of genre which include action, adventure, board, casual, card/casino, puzzle/trivia, racing, strategy and word. These formats are created using algorithms and computer code to produce gameplay environments where players compete against a computer or versus other people. Until recently, gameplay environments have been only computer generate settings. However, the interactive media such as augmented reality and virtual reality have expanded gameplay environments to include the physical world and other media.

Interactive puzzle video games have been limited to computer generated environments excluding the use of recorded and live stream media content. Puzzle video games test players cognitive and recall skills in computer generated settings that contain computer generated audio and visual elements. The puzzle game visual elements are contain characters, scenes and objects are generated using 2D and/or 3D graphics rendering techniques which include sprites, vectors and/or 3D models. Thematic visual elements are presented as moving objects or static images which require player input to answer questions and solve problems. Video game developers have not found a method and system to create puzzle gameplay environments from recorded and live streamed media content based on the actions, characters and scenes therein.

The consumption and enjoyment of recorded and live streamed media content is overwhelming one directional and lacks an interactive gameplay environment for the viewer to experience. Technological advances make it possible for the viewers of recorded and live streamed media content to access large amounts of content on devices like personal computers, smartphones, tablets, and TVs.

The subject technology addresses the foregoing limitations by providing a method and system that facilitates the creation and management of video game environments based on recorded and live videos. In this description player and user are used interchangeably to mean one person or group of people using the present invention for competition and enjoyment.

The present invention provides methods and systems for adding gamification to recorded and live streamed for media content for gameplay. The adding of gamification to recorded and live media can be applied to various genres of content by challenging a player to accurately identify the ephemeral elements occurring multiple times within the media environment. Ephemeral elements can be audio or visual elements that occur via the screen and speakers of a user's device. These and other details relating to the use of the recorded and live streamed media content to create a gameplay environment are discussed in more detail herein.

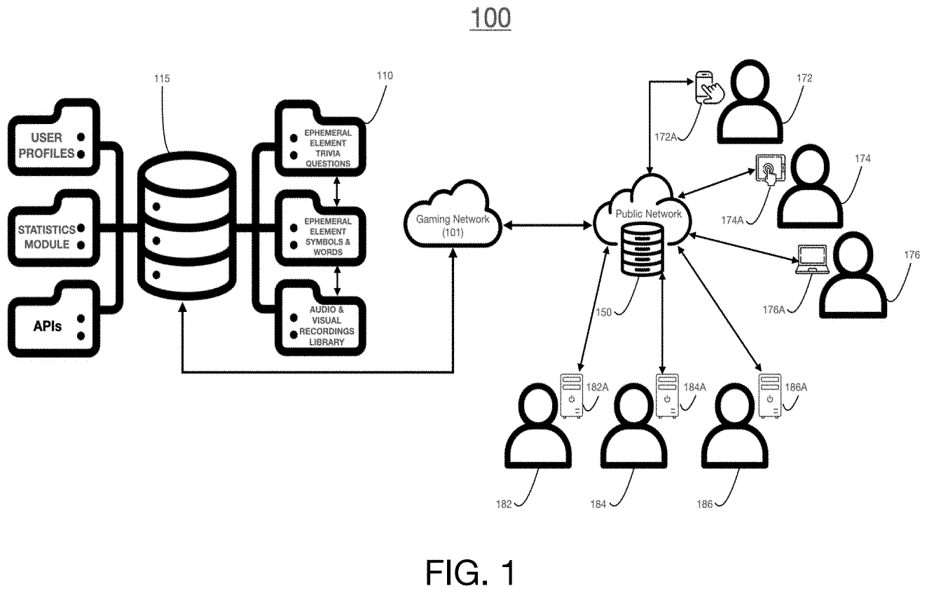

FIG. 1 illustrates an example of the network environment 100 in some of aspects of the technology can be implemented. Environment 100 includes public network 150, which can include one or more private networks, such as, a local area network (LAN), a wide area network (WAN), or a network of public/private networks, such as the Internet. Public network 102 is communicatively coupled to gaming network 101 that represents a network of computing resources configured for implementing gaming content management system 110 of the subject technology.

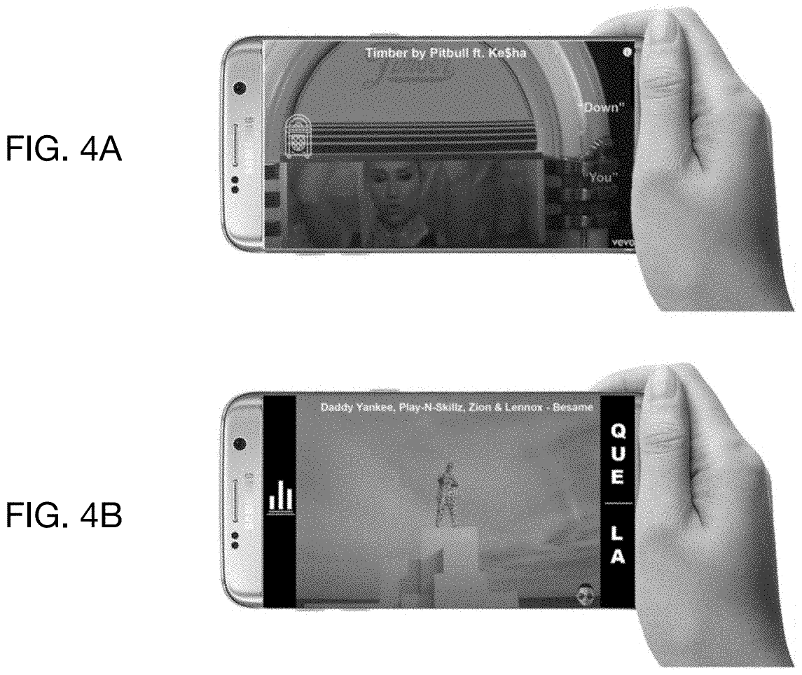

Public network 150 and gaming network 101 provide player and developer access to gaming content management system 112. As illustrated, players 172, 174, and 176 are permitted access to gaming content management system 112 using respective players devices (e.g., 172A, 174A, and 176A). Player devices 172A, 174A, and 176A are depicted as smart phones, table computer systems and a personal computer. It is understood that the client devices can include various types of processor-based systems, including but not limited to: game consoles and the like. Example of hardware systems that can be used to implement the client device are discussed in further detail below with respect to FIG. 4. Similarly, developers (e.g., 182, 184 and 186), are permitted access to gaming content management system via respective their computing systems (e.g., 182A, 184A, and 186A).

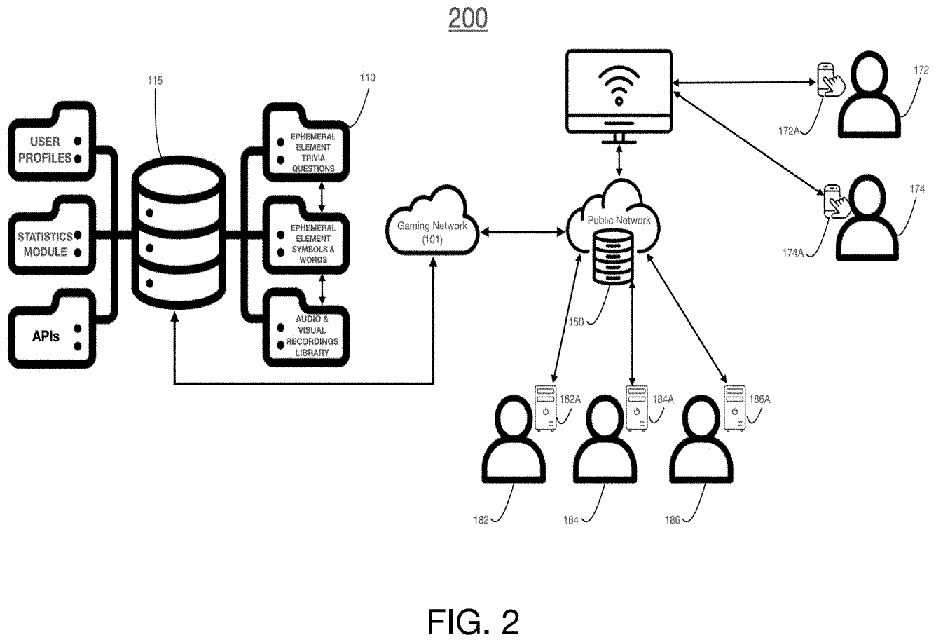

FIG. 2 illustrates an example of the network environment 200 in some of aspects of the technology can be implemented. Environment 200 includes public network 150, which can include one or more private networks, such as, a local area network (LAN), a wide area network (WAN), or a network of public/private networks, such as the Internet. Public network 102 is communicatively coupled to gaming network 101 that represents a network of computing resources configured for implementing gaming content management system 110 of the subject technology. In this aspect of the network environment, a smart TV 180 serves as the viewing device for recorded and live streamed media content gameplay environments. Players 172 and 174 utilize their respective player devices 172A and 174A as a means of receiving and transmitting gameplay events to gaming network 101 via smart TV 180 and public network 150. Here, the primary functions of the player device are to define gameplay environment parameters and register player recognition of ephemeral elements via haptic response.

It is understood that a greater (or fewer) number of players and/or developers can be engaged with environment 100, without departing from the scope of the technology.

In practice, management system 115 is configured to create and support gameplay environments from recorded and live streamed media content for competitions between various players, and to provide the interfaces (dashboard) necessary to enable users/players to define parameters for video format selection, obtain and provide a video's trivia questions and corresponding ephemeral element symbols and words, capture and transmit gameplay events, and navigate through the user flow. As such, management system 115 is configured to facilitate player competition across recorded and live streamed media content genres, as well as to facilitate the selection, capture and distribution of competitive gameplay events.

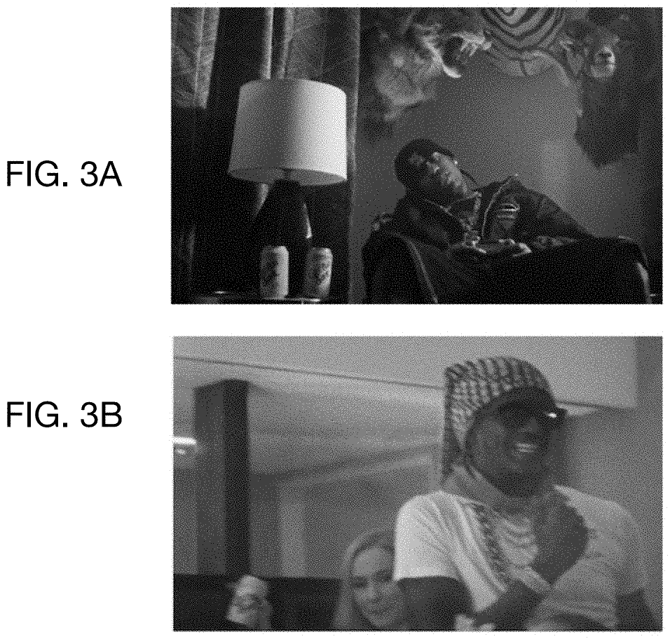

FIG. 2 illustrates an example of the ephemeral elements used evaluate player performance in the gaming method and system. Because the metrics that are used to evaluate player performance for a particular game can vary widely between recorded and live streamed media content type, in some aspects, game developers are encouraged to provide an indication of the specific game-performance attributes that should be used to evaluate player performance for the developer's game. The ephemeral element trivia questions and their corresponding symbols and words are provided to the player to communicate performance attributes for a particular video and to execute user gameplay events. The players use haptic inputs on the ephemeral element symbols and words imposed on the recorded or live streamed media content to attempt to accurately identify the number of occurrences of an elements. The dynamic and thematic natures of recorded and live streamed media content allow for ephemeral elements to be combined and configured into sets of elements. The still images from FIG. 3A and FIG. 3B are taken from the same recorded music video. Within one iteration of this recorded video's gameplay environment, a player made be asked to identify the combined occurrences of a soda can and table lamp. In another iteration of the same recorded video's gameplay environment, a player made be asked to identify the combined occurrences of a soda can and animal trophy heads. Changing the combinations of ephemeral elements will result in multiple unique gameplay environments in which a player will be challenged. In the example of ephemeral elements provided, the soda can, table lamp and trophy heads are displayed as 2D or 3D graphic symbols and serve as a player's means of registering recognition of game performance attributes.

In one embodiment of the present invention, recorded video in a gameplay environment will contain multiple ephemeral elements that occur based on the artistic direction of the video creator or theme of the content. The ephemeral elements in the gameplay environment are queried from the gaming content management system 110 and rendered as 2D or 3D graphic overlays providing haptic inputs to register and track a players recognition of ephemeral elements. One tap of the haptic input will register a count of one; two taps of the haptic input will register a count of two and so on. Upon initiation of play of the recorded video, the player will tap the symbol and word overlays to register and track occurrences of ephemeral elements. At the completion of the recorded video, the gaming content management system 110 will compare the haptic inputs of the player and compute a score based on the correct answers therein.

In one embodiment of the present invention, live streamed media content in a gameplay environment will contain multiple ephemeral elements that occur based on the direction of the video creator or theme of the content. In this embodiment, the ephemeral elements in the gameplay environment are queried from the gaming content management system 110 and rendered as 2D or 3D graphic overlays providing haptic inputs to register and track a players recognition of ephemeral elements. The air or streaming of the live streamed media content is not controlled by gaming content management system 110. One tap of the haptic input will register a count of one; two taps of the haptic input will register a count of two and so on. Upon initiation of airing or streaming of the media content, the player will tap the symbol and word overlays to register and track occurrences of ephemeral elements. At the completion of the air or streaming of the media content, the gaming content management system 110 will compare the haptic inputs of the player and compute a score based on the correct answers therein.

FIG. 4A and FIG. 4B illustrate an exemplary player interfaces in which the player device (smart phones, table computer systems or personal computer) displays both the recorded or live streamed media content (gameplay environment) and haptic inputs to register occurrences of ephemeral elements. The orientation and position of the haptic inputs may be placed as graphic overlays FIG. 4A or positioned on the border of the video frame FIG. 4B. It should be noted that the elements are exemplary and the other embodiments may incorporate more or less than the elements illustrated.

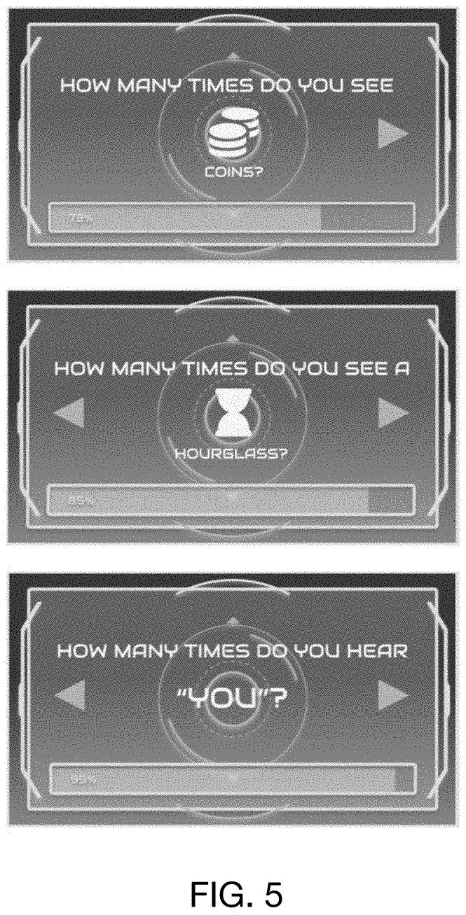

FIG. 5 illustrates an example of ephemeral element trivia questions and the corresponding symbols and words combinations that will be displayed in step 604. It is understood that due to the diverse nature of record and live streamed media content the ephemeral element trivia questions and symbols and words will be based on the underlying content. Additionally, the user interface shown in FIG. 5 may take various embodiments to convey the performance attributes of a recorded or live streamed media content.

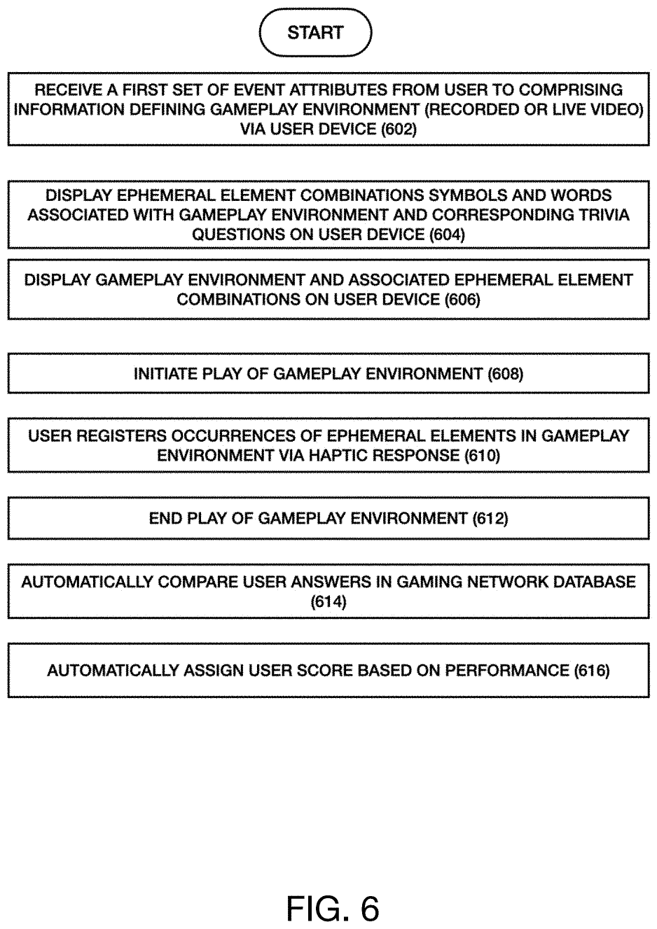

FIG. 6 illustrates steps of an example process 600 for defining a gameplay environment (e.g. recorded or live stream) and automatically providing the user with the corresponding ephemeral elements questions trivia and associated haptics inputs to track performance. Process 600 begins with steps 602, in which a set of attributes are received from the user at a game dashboard. The user provided attributes can include a genre of recorded or live stream, artist/performer/producer of media content and year of publication.

In step 602, the system receives parameters and attributes from the player device to select the recorded or live streamed media content to be displayed as the gameplay environment. The player will provide parameters such as artist name, category/genre and/or year of release for the content to be played. The player may select particular types of symbols and words attributes to be played en lieu of selecting other parameters corresponding to record or live media content.

In step 604, the player provided parameters will automatically query and display, on the player's viewing device, the ephemeral element trivia questions and ephemeral element symbols and words associated with a recorded or live stream media content. This step is needed to inform the player of the performance metrics for the video content.

In step 606, the selected gameplay environment (video content) and ephemeral element symbols and words are displayed on the player's viewing device. The viewing device can either be a smart phones, table computer systems or personal computer.

In step 608, the player initiates play of the record or viewing of the live stream video through the gaming network.

In step 610, the player begins to execute haptic inputs to register occurrences of the video's ephemeral elements which are logged and tracked by the gaming network.

In step 612, the video stops playing ending the display of the gameplay environment.

In step 614, the player's registered haptic inputs are computed in the gaming network database.

In step 616, the player's performance is assigned a score. The score may be rendered letter, numerical symbol format.

It is understood that any specific order or hierarchy of steps in the processes disclosed is an illustration of exemplary approaches. Based upon design preferences, it is understood that the specific order or hierarchy of steps in the processes may be rearranged, or that only a portion of the illustrated steps be performed. Some of the steps may be performed simultaneously. For example, in certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more.”

A phrase such as an “aspect” does not imply that such aspect is essential to the subject technology or that such aspect applies to all configurations of the subject technology. A disclosure relating to an aspect may apply to all configurations, or one or more configurations. A phrase such as an aspect may refer to one or more aspects and vice versa. A phrase such as a “configuration” does not imply that such configuration is essential to the subject technology or that such configuration applies to all configurations of the subject technology. A disclosure relating to a configuration may apply to all configurations, or one or more configurations. A phrase such as a configuration may refer to one or more configurations and vice versa.

The word “exemplary” is used herein to mean “serving as an example or illustration.” Any aspect or design described herein as “exemplary” is not necessarily to be construed as preferred or advantageous over other aspects or designs.

1. A system for providing a gameplay environment comprising: a audio and visual media content database; a trivia question database comprising gaming network: questions to determine the numerical occurrences of ephemeral elements within audio and video media content, the elements therein represented by symbols and words; a numerical tally of occurrences of ephemeral elements within audio visual media content; and a network interface, the network interface to display audio and visual media content, trivia questions for ephemeral elements and corresponding symbols and words on one or more users devices: the device sending database requests to select audio and visual media content, ephemeral element trivia questions to determine the numerical occurrences of ephemeral elements and corresponding symbols; receiving user haptic inputs, the inputs registering user's audio and visual recognition of the ephemeral element occurrences, the occurrences resulting in a game-play event; and automatically providing a score.

2. The system of claim 1, wherein network interface automatically displays one or more ephemeral elements to form a singular or plurality of performance attributes for users to compete against.

3. The system of claim 1, wherein one or more user devices register haptic input to recognize the occurrences of ephemeral elements of recorded or live streamed audio and visual media based on predetermined trivia questions.

4. The system of claim 1, wherein haptic inputs to register the occurrence ephemeral elements embody the action of targeting, capturing and shooting.

5. The system of claim 1, wherein user selected audio and visual media content create a mashup of consecutively played recordings and provide users with corresponding ephemeral element questions and element symbols and words to produce a combined performance score

6. The system of claim 1, wherein a plurality of users play audio and visual media content concurrently.

7. The system of claim 1, wherein a plurality of users play audio and visual media asynchronously.

8. The system of claim 1, wherein a secondary device displays audio and visual media content, trivia questions associated with audio and visual media content ephemeral element and receives user device haptic inputs to register recognition of gameplay attributes

9. The system of claim 1, wherein the user inputs comprise one or more of: assigned a score, achievement of a high-score, attainment of a predetermined game level, or occurrence of a predetermined win/loss record.

10. The system of claim 1, wherein combined performance scores based on ephemeral element recognition is used to rank, eliminate and promote users to higher game levels and tournament style competition.

11. A method for providing a gameplay environment comprising:
displaying network interface, the network interface to transmit audio and visual recorded media content on one or more user devices;
receiving a set of event attributes from a network interface to select recorded audio and visual content;
displaying one or more trivia questions from a database within a gaming network and corresponding ephemeral elements represented by symbols and words linked to recorded audio and visual media content;
receiving user haptic inputs to register user's recognition of the occurrence of audio and visual ephemeral elements within recorded media content to create a gameplay event;
automatically computing and generating a score based on user haptic inputs.

12. A method for providing a gameplay environment comprising:
displaying network interface, the network interface to transmit audio and visual live streamed media content on one or more user devices;
receiving a set of event attributes from a network interface to select live streamed audio and visual content;
displaying one or more trivia questions from a database within a gaming network and corresponding ephemeral elements represented by symbols and words associated to live streamed audio and visual media content based on predetermined trivia questions;
receiving user haptic inputs to register user's recognition of the occurrence of audio and visual ephemeral elements within live streamed media content to create a gameplay event;
automatically computing and generating a score based on user haptic inputs.

13. A method for providing a gameplay environment and trivia database, the method comprising:
identifying ephemeral elements of audio and visual media content and creating trivia questions to challenge a user;
aggregating the number of occurrences of ephemeral elements of audio and visual media content manually or via machine learning;
creating symbols and word graphic representations of ephemeral elements to serve as user haptic inputs to register gameplay events;

14. An interface comprising: at least one processor; and at least one memory device electronically coupled to the at least one processor, in which the at least one memory device stores software that when executed by the at least one processor, directs the at least one processor to: receive a request from multiple mobile devices to access a private gaming network; in response to determining that the mobile devices have permission to access the private database, enable the mobile devices to jointly participate in a common gaming activity.

15. A common gaming activity comprises of counting and tracking the number of audio and visual occurrences of a predetermined objects within streaming video on-demand to create a common gaming activity.

16. A non-transitory computer-readable medium comprising software that when executed by at least one processor directs the at least one processor to: receive a request from a first mobile device and a second mobile device to access a private gaming group; in response to determining that the first mobile device and the second mobile device have permission to access the private gaming group, enable the first mobile device and the second mobile device to jointly participate in a common gaming activity; determine first location information associated with the first mobile device based on at least one of a receiver strength indicator, time difference of arrival, multilateration, triangulation, geo-fencing, and global satellite positioning; determine second location information associated with the second mobile device based on at least one of a receiver strength indicator, time difference of arrival, multilateration, triangulation, geo-fencing, and global satellite positioning; based at least in part on determining the first and the second location information, determine a distance between the first mobile device and the second mobile device; based at least in part on determining the distance between the first mobile device and the second mobile device, determine that a distance requirement has been violated, in which the distance requirement comprises a minimum distance that must be maintained between the first mobile device and the second mobile device when providing the common gaming activity; based at least in part on determining that the distance requirement has been violated, disable the common gaming activity at the first mobile device and the second mobile device; and based at least in part on determining that the distance requirement has not been violated, enable the common gaming activity at the first mobile device and the second mobile device, wherein the first mobile device and the second mobile device exchange location information and display the location information on respective screens.

17. A non-transitory computer-readable storage medium, having embodied thereon a program executable by a processor to perform operations comprising: receiving a user request, via the network interface, the user request comprising information selecting an audio or visual recording, wherein the corresponding trivia questions are displayed and a first game-play event associated with the first game title; monitoring a plurality of video feeds corresponding to play of the first game title by one or more other users to detect occurrence of the game-play event; filtering the plurality of video feeds to identify a set of video feeds that include at least one occurrence of the game-play event; and automatically providing a video stream comprising the filtered set of video feeds to the first user.
